(19) United States
(12) Patent Application Publication
(10) Pub. No.: US 2024/0001944 A1
(43) Pub. Date: Jan. 4, 2024

(54) Method for Determining a Defect State of a Drive Train of a Vehicle, Monitoring Unit and Vehicle

(71) Applicant: ZF CV Systems Global GmbH, Bern (CH)

(72) Inventors: Dirk Hillbring, Celle (DE); Mark Schaper, Hannover (DE)

(21) Appl. No.: 18/467,525

(22) Filed: Sep. 14, 2023

Related U.S. Application Data
(63) Continuation of application No. PCT/EP2022/055072, filed on Mar. 1, 2022.

(30) Foreign Application Priority Data
Mar. 31, 2021 (DE) 10 2021 108 222.6

(51) Int. Cl. B60W 50/02; B60W 50/04; B60W 10/04

(52) U.S. Cl. CPC B60W 50/0205; B60W 50/045; B60W 10/04; B60W 2050/021

(57) ABSTRACT

A method determines a defect state of a drive train of a vehicle having a drive axle with a drive wheel and a reference axle with a reference wheel. A drive torque generated by a drive is transferrable to an underlying surface by the drive train via the drive wheel and cannot be transferred to the underlying surface via the reference wheel of the reference axle. The method includes: reading-in a drive variable which is dependent on a motor revolution rate of the drive; reading-in a reference variable which is dependent on a reference wheel revolution rate of the reference wheel; determining whether there is a deviation between the read-in drive and the read-in reference variables to determine whether the reference wheel revolution rate is related to the motor revolution rate of the drive. If there is a deviation, a defect state of the drive train is concluded.

### CROSS-REFERENCE TO RELATED APPLICATIONS

This application is a continuation application of international patent application PCT/EP2022/055072, filed Mar. 1, 2022, designating the United States and claiming priority from German application 10 2021 108 222.6, filed Mar. 31, 2021, and the entire content of both applications is incorporated herein by reference.

### TECHNICAL FIELD

The disclosure relates to a method for determining a defect state of a drive train, a monitoring unit for carrying out the method, and a vehicle.

### BACKGROUND

As a result of defects, temporary functional impairments can occur in the drive train of vehicles if the drive torque generated by the motor or drive cannot be continuously transferred completely to the wheels and thus to the underlying surface. Furthermore, consequential damage can occur due to defects in individual components of the drive train. For example, improperly fastened wheels or defective sprockets in the drive train or defective tires can lead to permanent failure of the drive train as well as to dangerous accidents caused by loosening components.

If, for example, wheel nuts that attach the wheel to a wheel hub of the vehicle are unintentionally partially or completely loosened, these as well as the wheels that are then no longer fully fastened can pose a danger to the surrounding traffic and to neighboring persons. In addition, a wheel nut that is not fully tightened causes threaded bolts, on which the wheels sit and on which the wheel nuts are screwed, to move in holes in the rims of the wheel with play. As a result, both the threaded bolts and the holes in the rims are badly worn, preventing reliable attachment of the wheel to the wheel hub.

The monitoring of the drive train for such defects can be carried out visually by the driver before or after the journey, for example. However, manual monitoring while driving is usually not possible. In the case of automatically controlled vehicles, there is also no driver, so reliable automatic detection must be used to ensure safe and reliable autonomous driving. Such a situation is not yet known.

### SUMMARY

It is an object of the disclosure to specify a method for determining a defect state of a drive train of a vehicle with which safe and reliable driving operation can be ensured. This object is, for example, achieved via a method for determining a defect state of a drive train of a vehicle, wherein the vehicle has a drive axle with a drive wheel and a reference axle with a reference wheel, wherein a drive torque generated by a drive is transferrable to an underlying surface by the drive train via the drive wheel and the drive torque of the drive is not transferrable to the underlying surface via the reference wheel of the reference axle. The method includes: reading-in a drive variable, wherein the drive variable is dependent on a motor revolution rate of the drive; reading-in a reference variable, wherein the reference variable is dependent on a reference wheel revolution rate of the reference wheel; determining whether there is a deviation between the read-in drive variable and the read-in reference variable for determining whether the reference wheel revolution rate of the reference wheel is related to the motor revolution rate of the drive, wherein if there is a deviation, the defect state of the drive train is concluded; and outputting a state signal if the drive train is in the defect state.

It is a further object of the disclosure to specify a monitoring unit. This object is, for example, achieved via a monitoring unit for a vehicle wherein the vehicle has a drive axle with a drive wheel and a reference axle with a reference wheel, wherein a drive torque generated by a drive is transferrable to an underlying surface by a drive train of the vehicle via the drive wheel and the drive torque of the drive cannot be transferred to the underlying surface via the reference wheel of the reference axle. The monitoring unit includes: a non-transitory storage medium having program code stored thereon; the program code being configured, when executed by a processor, to: read-in a drive variable, wherein the drive variable is dependent on a motor revolution rate of the drive of the vehicle; read-in a reference variable, wherein the reference variable is dependent on a reference wheel revolution rate of the reference wheel of the vehicle; determine whether there is a deviation between the read-in drive variable and the read-in reference variable in order to determine whether the reference wheel revolution rate of the reference wheel is related to the motor revolution rate of the drive, wherein if there is a deviation the monitoring unit can conclude that there is a defect state of the drive train of the vehicle; and, output a state signal if the drive train is in the defect state.

It is a further objective of the disclosure to specify a vehicle having a monitoring unit. This objective is, for example, achieved via a vehicle including: a drive axle with a drive wheel; a reference axle with a reference wheel; a drive train; a drive configured to generate a drive torque, wherein the drive torque is transferable to an underlying surface by the drive train via the drive wheel and the drive torque is not transferrable to the underlying surface via the reference wheel; a drive revolution rate sensor being assigned to the drive axle and configured to determine a drive variable; a reference revolution rate sensor being assigned to the reference axle and configured to determine a reference variable; a monitoring unit including a non-transitory storage medium having program code stored thereon; the program code being configured, when executed by a processor, to read-in the drive variable, wherein the drive variable is dependent on a motor revolution rate of the drive of the vehicle; read-in the reference variable, wherein the reference variable is dependent on a reference wheel revolution rate of the reference wheel of the vehicle; determine whether there is a deviation between the read-in drive variable and the read-in reference variable in order to determine whether the reference wheel revolution rate of the reference wheel is related to the motor revolution rate of the drive, wherein if there is a deviation, the monitoring unit can conclude that there is a defect state of the drive train of the vehicle; and, output a state signal if the drive train is in the defect state.

According to the disclosure, a method for determining a defect state of a drive train of a vehicle is therefore provided, wherein the vehicle has a drive axle with a drive wheel and a reference axle with a reference wheel, wherein a drive torque generated by a drive can be transferred to an underlying surface by the drive train via the drive wheel and the drive torque of the drive cannot be transferred to the underlying surface via the reference wheel of the reference axle, with at least the following steps:

reading-in a drive variable, wherein the drive variable is dependent on a motor revolution rate of the drive and therefore characterizes the rotational behavior or the drive behavior of the drive axle, wherein the drive variable is preferably directly given by the motor revolution rate of the drive, for example by a resolver (angle encoder) in an electric machine;

reading-in a reference variable, wherein the reference variable is dependent on a reference wheel revolution rate of the reference wheel and therefore characterizes the rotational behavior of the reference axle;

determining whether there is a deviation between the read-in drive variable and the read-in reference variable in order to determine whether the reference wheel revolution rate of the reference wheel is related to the motor revolution rate of the drive, wherein if there is a deviation a defect state of the drive train is concluded; and outputting a state signal if there is a defect state of the drive train, which is equivalent to the omission of a permanently output state signal if there is a defect state.

Therefore, it is possible to check in a simple and reliable way whether a generated drive torque is transferred to the underlying surface via the drive train by comparing the rotational behavior or the drive behavior of the drive axle with the rotational behavior of the non-driven reference axle. If this is not the case due to a defect, it is to be expected that there will be a difference in the rotational behavior of the two axles, wherein the rotational behavior of the respective axle can be given by the drive variable or the reference variable. Thus, it is preferable to draw conclusions about a defect simply with sensors already present in the vehicle. This can be carried in a monitoring unit according to the disclosure, which is configured to carry out the method according to the disclosure.

Preferably, it can provided be that if there is a deviation between the read-in drive variable and the read-in reference variable, a defect state of the drive train is concluded, taking into account a normal state of the drive train. When evaluating the deviation, it is therefore advantageous to also take into account whether a certain deviation results from a usual, expected behavior of the drive train or whether this usual behavior at least contributes to a deviation to a certain extent. For example, when new, there may already be a certain amount of play in the components of the drive train, although this normally occurring play when a system change occurs is not due to a defect state. Only if the play increases, for example due to wear or loosening of the components of the drive train (starting from the new condition), can this be indicated as a defect state by the evaluation according to the disclosure.

In this case, it can therefore preferably be provided that a defect state is not concluded if a deviation between the read-in drive variable and the read-in reference variable is caused solely or exclusively due to a normal state of the drive train, that is, due to an expected behavior of the drive train, wherein in the normal state the drive train does not have a defect despite a detected deviation between the read-in drive variable and the read-in reference variable. In this way, a certain expected deviation can be taken into account when determining the defect state. If, for example, only a learned first offset occurs temporarily or non-periodically in the oscillating drive variable, which is associated with normal behavior of the drive train, this can be disregarded or a defect state can continue to be excluded if other causes do not also contribute to an additional deviation.

Preferably, it can also be provided that the deviation between the read-in drive variable and the read-in reference variable that can be determined in a normal state is learned in advance. In previous tests, for example, it can be determined that a deviation between the read-in drive variable and the read-in reference variable in the normal state results from a tolerance-related or usual and therefore to be expected gearwheel play in a gearbox of the drive train. In this way, the determination of the defect state can be carried out more accurately and quickly if such common effects are learned in advance.

Preferably, it can also be provided that a defect state is only or exclusively concluded from a deviation between the read-in drive variable and the read-in reference variable if this deviation is in the event of or as a result of

a change in the drive torque transferred to the underlying surface via the drive wheel and/or

a change in a braking torque transferred to the underlying surface via the drive wheel.

It is therefore advantageously assumed that defects can be detected primarily in the case of a change in the acting drive torque or generally in the torques acting in the drive train. Thus, if an induced force or torque on the individual drive components changes, it can be assumed that this changed torque will be transferred via the drive train delayed or disturbed in the event of a defect, for example caused by a system change in the presence of wear-related play or a loosened component in the drive train. This delay or disturbance can be determined in the form of a deviation that occurs at least temporarily by comparison with the rotational behavior of the reference wheel, which does not experience this disturbance when the drive torque or braking torque changes

Preferably, it can also be provided that a defect state can only or exclusively be concluded from a deviation between the read-in drive variable and the read-in reference variable if this deviation results
from a change in the drive torque of the drive with a sign change, or
from a change in the drive torque of the drive and/or the braking torque to zero, or
from a change in the drive torque of the drive and/or the braking torque starting from zero.

A change is to be understood to mean that there was previously a different drive torque or braking torque on the drive axle. Thus, there is a zero crossing with a positive or negative gradient for the drive torque or a decrease or rise to zero for the drive torque and/or the braking torque.

Preferably, it can also be provided that the drive variable and the reference variable each have an oscillating curve, wherein the drive variable and the reference variable are recorded by an incrementally measuring revolution rate sensor. This makes it possible to detect a change or deviation in the respective variables in a high-resolution manner if a defect state occurs only temporarily and briefly. This defect state can be well represented in an oscillating behavior.

Preferably, it can be provided for this purpose that a defect state of the drive train is concluded if the deviation is caused by a second offset in the drive variable, wherein the second offset is caused by a changed period length of the oscillating curve of the drive variable, wherein the second offset in the oscillating curve of the reference variable cannot be detected. By analyzing the period length or the frequency with the same effect, a deviation can be determined in a simple way.

Preferably, it can also be provided that the period length of the oscillating curve of the drive variable changes briefly and not periodically if there is a defect state of the drive train. This makes it easy to identify whether a deviation occurs due to a one-off effect, which may be coupled to the torque in the drive train, or due to a recurring systematic effect that is to be expected.

Preferably, it can also be provided that a defect state exists if a wheel nut attaching the drive wheel to a drive wheel hub is so loose that there is a deviation between the read-in drive variable and the read-in reference variable in the event of a change in the drive torque transferred to the underlying surface via the drive wheel and/or a change in a braking torque transferred to the underlying surface via the drive wheel, since the reference wheel revolution rate of the reference wheel is at least temporarily no longer related to the motor revolution rate of the drive. This can be caused by the fact that when a wheel nut is loosened, the threaded bolt can move in a hole in the rim depending on the sign of the torque in the drive train and can change between two stops depending on the torque generated, which means that the drive torque/braking torque is not consistently transferred to the underlying surface. This can be temporarily determined in a simple way from a deviation, especially if the generated torque (drive torque/braking torque) changes sign or rises or falls to zero.

Preferably, it can also be provided that

the motor revolution rate of the drive and/or a drive hub revolution rate of a drive wheel hub in the same drive train as the drive is read-in as the drive variable is, wherein the drive wheel is arranged on the drive wheel hub and the drive hub revolution rate corresponds to the motor revolution rate of the drive at least during the transmission of a drive torque, and/or a reference hub revolution rate of a reference wheel hub on the reference axle is read-in as a reference variable, wherein the reference wheel is arranged on the reference wheel hub.

In this way, a sensor system that is already present in the vehicle can be used for monitoring, wherein the reference variable can be determined, for example, with a wheel revolution rate sensor on the reference axle, which is already present as part of an ABS system. The drive variable can be determined via a motor revolution rate sensor, which directly measures the motor revolution rate, or even via a wheel revolution rate sensor on the drive axle, which is also part of an ABS system.

A vehicle according to the disclosure, in particular a commercial vehicle, may be equipped with a monitoring unit according to the disclosure, wherein the vehicle has a drive axle with a drive wheel and a reference axle with a reference wheel, wherein a drive torque generated by a drive can be transferred to an underlying surface by the drive train of the vehicle via the drive wheel and the drive torque of the drive is not transferred to the underlying surface via the reference wheel of the reference axle, wherein the drive axle is assigned a drive revolution rate sensor for determining the drive variable and the reference axle is assigned a reference revolution rate sensor for determining the reference variable.

Preferably, it is provided that the drive is an electric motor for generating the drive torque and the drive revolution rate sensor is a motor revolution rate sensor, which directly detects a motor revolution rate as the drive variable.

### BRIEF DESCRIPTION THE DRAWINGS

The invention will now be described with reference to the drawings wherein:

FIG. 1 shows a schematic view of a vehicle;

FIG. 2 shows the drive behavior of the wheels of the vehicle according to FIG. 1;

FIGS. 3, 4, 5 show oscillating behavior of the signals of revolution rate sensors;

FIG. 5A shows a system change as a result of a loose wheel nut as a defect state of the drive train; and,

FIG. 6 shows a flowchart of a method according to the disclosure.

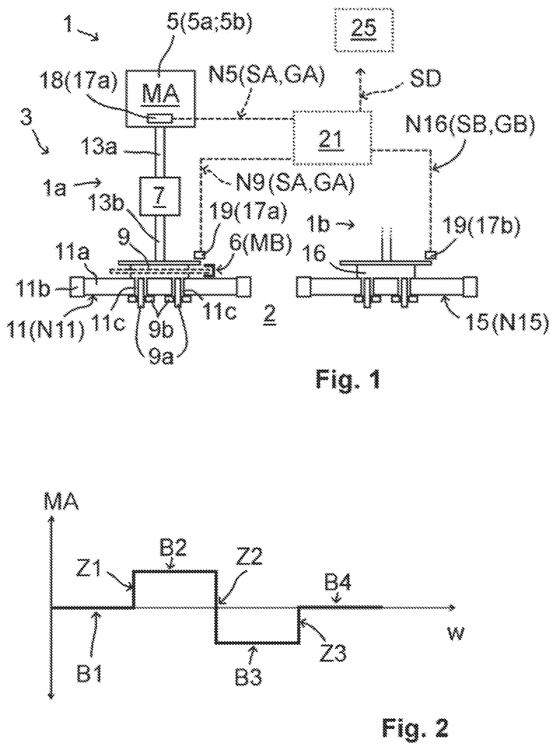

FIG. 1 shows a highly schematized vehicle 1, which is located on an underlying

### DETAILED DESCRIPTION

surface 2 and which has at least two axles 1a, lb. The vehicle 1 can be a towing vehicle (motor vehicle, tractor, et cetera) or a trailer (drawbar trailer, semi-trailer, et cetera). A drive axle 1a of the vehicle 1 is part of a drive train 3 of the vehicle 1. The drive train 3 includes all drive components that generate the drive power in the vehicle 1 and transfer it to the underlying surface 2. The drive train 3 therefore includes, in particular, a drive 5, for example an electric motor 5a or an internal combustion engine 5b, a gearbox 7, a drive wheel hub 9, a drive wheel 11 with a rim 11a and tire 11b mounted on it, as well as suitable transmission elements between the aforementioned drive components. The drive train 3 may also have other drive components that are not shown.

The drive 5 is connected to the gearbox 7 via a first drive shaft 13a and the gearbox 7 is connected to the drive wheel hub 9 via a second drive shaft 13b. The drive wheel 11 is attached to the drive wheel hub 9, wherein the drive wheel hub 9 has multiple threaded bolts 9a for this purpose, each of which is guided through holes 11c in the rim 11a of the drive wheel 11. Wheel nuts 9b that are screwed onto the threaded bolts 9a inserted through the holes 11c press the rim 11a against the drive wheel hub 9 and thereby securely attach the drive wheel 11 to the drive wheel hub 9 when tightened. If sufficiently fastened, the drive moment MA (torque) generated by the drive is transferred via the gearbox 7 to the drive wheel hub 9 and transferred directly to the underlying surface 2 via the tire 11b.

In addition to the drive axle 1a, the vehicle has a reference axle 1b, which is not driven in the embodiment shown. A reference wheel 15 that is provided on the reference axle 1b is, for example, attached to a reference wheel hub 16 via threaded bolts 9a and wheel nuts 9b in the same way as the drive wheel 11. However, other fastenings may also be provided. The reference wheel 15 on the reference axle 1b, which in this case is not driven, rotates automatically as a result of a movement of the vehicle 1 induced by the drive wheel 11 on the drive axle 1a by rolling on the underlying surface 2. The drive torque MA is therefore not transferred directly from the drive 5 to the reference wheel 15 of the reference axle 1b.

According to the embodiment shown, the rotational behavior of the drive axle 1b can be determined via two drive revolution rate sensors 17a in the form of a motor revolution rate sensor 18 and a wheel revolution rate sensor 19 which are also assigned to the drive axle 1a. The motor revolution rate sensor 18 is configured to detect a variable related to the motor revolution rate N5 of the drive 5 in a high resolution manner directly on the drive 5. Such a motor revolution rate sensor 18 is, for example, an integral part of an electric motor 5a driving the vehicle 1.

For example, the wheel revolution rate sensor 19 measures a variable related to a drive hub revolution rate N9 of the drive wheel hub 9. Since the drive wheel hub 9 is connected to the drive 5 via the drive shafts 13a, 13b and the gearbox 7, the drive hub revolution rate N9 ideally corresponds to the motor revolution rate N5 when in the engaged state, provided that there are no defects in the drive train 3 between the drive 5 and the drive wheel hub 9.

In the embodiment shown, a reference revolution rate sensor 17b, in this case also a wheel revolution rate sensor 19, is assigned to the reference axle 1b. This measures a variable related to the reference hub revolution rate N16 of the reference wheel hub 16 and thus the rotational behavior of the reference axle 1b. For example, the wheel revolution rate sensors 19 on the respective axles 1a, 1b are part of an ABS control system in the vehicle 1. If it is assumed from this that the respective wheel 11, 15 is correctly attached to the respective wheel hub 9, 16, the respective hub revolution rate N9, N16 also corresponds to a wheel revolution rate N11, N15 of the respective wheel 11, 15 at the same time if a synchronous wheel motion is assumed.

For example, the revolution rate sensors 18, 19 can be implemented as incremental sensors (incremental encoders), for example with optical or magnetic sampling. Consequently, the respective revolution rate sensors 17a, 17b emit signals, that is, a drive signal SA, which characterizes the rotational behavior of the drive axle 1a (motor revolution rate N5 or drive hub revolution rate N9), or a reference signal SB, which characterizes the rotational behavior of the reference axle 1b (reference hub revolution rate N16), which are transferred to a monitoring unit 21 for further processing.

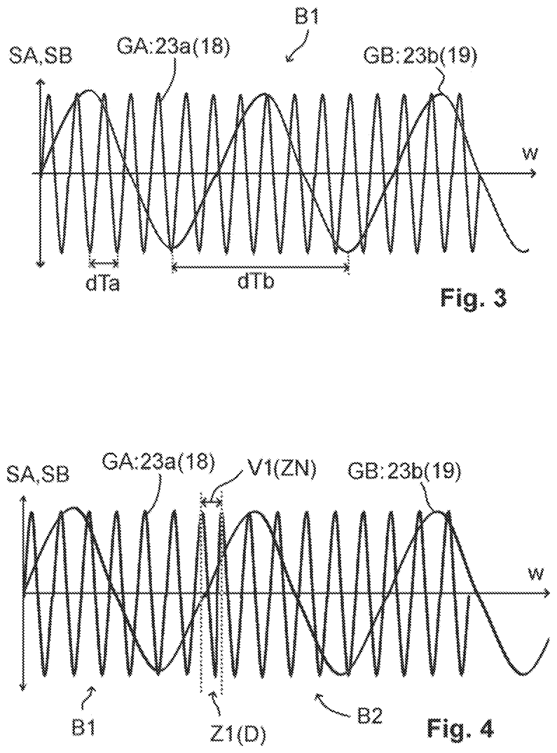

By way of example, the drive signal SA, which is detected by a motor revolution rate sensor 18 as the drive revolution rate sensor 17a in the drive train 3, and the reference signal SB, which is detected by a wheel revolution rate sensor 19 as the reference revolution rate sensor 17b on the reference axle 1b, are shown in FIG. 3. Both signals SA, SB are recorded in the same driving position or at the same time, that is, they reflect the rotational behavior of the respective axles 1a, 1b in the same driving situation.

In the case of an incrementally measuring sensor, the drive signal SA and the reference signal SB each transmit an oscillating curve 23a (SA), 23b (SB), which follows from the incremental sampling and from which the rotational behavior of the respective axle 1a, 1b can be derived. The oscillating sinusoidal signal curve is only an example, wherein alternatively a square wave signal could also be used for evaluation. The drive signal SA and the reference signal SB are plotted in FIG. 3 against the travel distance w (x-axis), so that in each case a velocity-independent oscillating curve 23a, 23b with a constant period length dTa, dTb results. From FIG. 3 it can accordingly be concluded from that both the drive axle 1a and the reference axle 1b run synchronously over the travel distance w shown, wherein it can be concluded that a drive torque MA generated by the drive 5 is transferred to the underlying surface 2 undisturbed via the drive train 3, in particular via the drive wheel 11, and that the reference wheel 15 follows this drive movement directly.

The period length dTa, dTb of the respective oscillating curve 23a, 23b is dependent on the resolution of the respective revolution rate sensor 17a (18), 17b (19). From FIG. 3, due to the shorter period durations dTa, that is, shorter increments, for the oscillating drive curve 23a, it can be concluded that the motor revolution rate sensor 18 used on the drive axle 1a has a higher resolution than the wheel revolution rate sensor 19 (oscillating reference curve 23b) on the reference axle 1b, which is used, for example, with a pole wheel in a conventional ABS control system. In principle, a wheel revolution rate sensor 19 with higher resolution can also be used, that is, the period lengths dTa, dTb of the two curves 23a, 23b can approach each other.

With such a setup, it can be shown, as described below, whether there are deviations between the rotational behavior of the drive axle 1a, which is characterized by the oscillating drive curve 23a, and the rotational behavior of the reference axle 1b, which is characterized by the oscillating reference curve 23b. From this, it can be concluded whether the drive torque MA generated by the drive 5 is permanently and completely transferred to the underlying surface 2 (and via this indirectly to the reference axle 1b) or whether interruptions in the torque transfer indicate a defect in the drive train 3. For this purpose, the method according to the disclosure according to FIG. 6 can be carried out as follows:

First, in a first step ST1, a drive variable GA characterizing the rotational behavior of the drive axle 1a, for example the motor revolution rate N5 and/or the drive hub revolution rate N9, which is determined by at least one of the drive revolution rate sensors 17a in the drive train 3, is read-in by the monitoring unit 21. The drive variable GA is characterized by the fact that it can reproduce as accurately as possible the rotational behavior of the drive axle 1a as a result of manual or automated actuation of the drive 5, that is, it corresponds as closely as possible to the motor revolution rate N5 of the drive 5 or is dependent on it. The closer the measuring point of the drive variable GA is to the drive 5, the more precisely the drive variable GA meets this requirement.

At the same time, the determination of the condition of the drive train 3 via the method according to the disclosure becomes more accurate, the closer the drive variable GA is measured to the drive 5. If, for example, there is a defect in the gearbox 7, no defect can be detected in the gearbox 7 itself by measuring the drive variable GA (as seen from the drive 5) downstream of the gearbox 7, since the method according to the disclosure can only be used to monitor the rotational behavior (seen from the drive 5) downstream of the measuring point of the drive variable GA.

In a second step ST2, a reference variable GB characterizing the rotational behavior of the reference axle 1b, for example the reference hub revolution rate N16, which is measured via the reference revolution rate sensor 17b on the assigned reference axle 1b, is read-in by the monitoring unit 21.

The two steps ST1 and ST2 are carried out consecutively, wherein different driving situations may arise, which are shown in FIG. 2. In FIG. 2, the drive torque MA generated by the drive 5 is plotted against the travel distance w. In a first region B1, the drive 5 is idling, that is, no drive torque MA is transferred from the drive 5 to the drive wheels 11 via the drive train 3, that is, the vehicle 1 is in a so-called coasting mode. From this it follows that the rotational behavior of the drive axle 1a and the reference axle 1b shown in FIG. 3 are as already described, wherein in the ideal case with interaxially synchronized wheel rotational behavior the motor revolution rate N5 (drive variable GA) corresponds to the reference hub revolution rate N16 (reference variable GB) over the entire travel distance w in the first region B1.

In a second region B2 (see FIG. 2), the vehicle 1 is accelerated by a corresponding actuation of the drive 5, that is, a corresponding drive torque MA generated by the drive is transferred to the underlying surface 2 via the drive wheels 11 and by the underlying surface 2 to the reference wheels 15. Even if a change over time of the motor revolution rate N5 and the reference hub revolution rate N16 is to be expected in the second region B2, this is not visible when the motor revolution rate N5 (drive variable GA, drive signal SA) and the reference hub revolution rate N16 (reference variable GB, reference signal SB) are plotted against the travel distance w, as shown in FIG. 4. The period lengths dTa, dTb thus remain identical to the first region B1 in the second region B2 according to the resolution of the respective revolution rate sensor 17a, 17b.

However, there is a difference in a first intermediate region Z1 between the first region B1 and the second region B2 (see FIG. 2 and FIG. 4), in which the change in the driving situation (coasting=>acceleration) is initiated. In the first intermediate region Z1, this results in a first offset V1 in the period duration dTa or in the frequency of the oscillating drive curve 23a, which is detected by the motor revolution rate sensor 18 on the drive axle 1a. This first offset V1 is not visible in the oscillating reference curve 23b of the wheel revolution rate sensor 19 on the reference axle 1b, so that in the present case a deviation D between the read-in drive variable GA and the read-in reference variable GB can be determined. From this it can be concluded that the first offset V1 follows from the rotational behavior of the drive axle 1a.

The first offset V1 shown, for example, results from the fact that there is normally a small amount of play between the sprockets of the gearbox 7, so that the sprockets briefly twist relative to each other during the transition from idling/coasting (B1) to the acceleration phase (B2) and thus no drive torque MA is transferred to the underlying surface 2 from the drive 5 via the drive train 3 for a short time. This results in a short-term jump when this drive signal SA in the form of the motor revolution rate N5 is plotted as the gearbox variable GA against the travel distance w. The reference signal SB or the reference hub revolution rate N16 as the reference variable GB is not subject to this jump since it is not transferred to the underlying surface 2 via the drive wheel 11 and thus not to the reference axle 1b.

This first offset V1, which usually results from a tolerance-related gearwheel play ZN1 in the gearbox 7, can be learned by the monitoring unit 21 and can therefore be taken into account in the respective evaluations by the monitoring unit 21 as the normal state ZN of the drive train 3. Therefore, when determining the first offset V1 as the deviation D between the read-in drive variable GA and the read-in reference variable GB, the monitoring unit 21 can conclude that it is highly probable that this does not result from a defect in the drive train 3 but occurs due to an expected transmission effect in the drive train 3. As a result, in the case of behavior according to FIG. 4 no defect state ZD of the drive train 3 will be determined and output.

If the drive signal SA is measured downstream of the gearbox 7, for example by a wheel revolution rate sensor 19 (drive revolution rate sensor 17a) on the drive axle 1a, which measures the drive hub revolution rate N9, this first offset V1 is not recorded as the normal state ZN, since it can no longer be detected downstream of the gearbox 7, which causes the jump.

In a third region B3 (see FIG. 2), the vehicle 1 is decelerated by a corresponding actuation of the drive 5 and/or the brakes 6, that is, a corresponding negative drive torque MA (drag torque) generated by the drive 5 in a recuperation phase or a braking torque MB generated by the brakes 6 in a braking phase is transferred to the underlying surface 2 via the drive wheels 11, whereupon the reference wheels 15 also rotate more slowly.

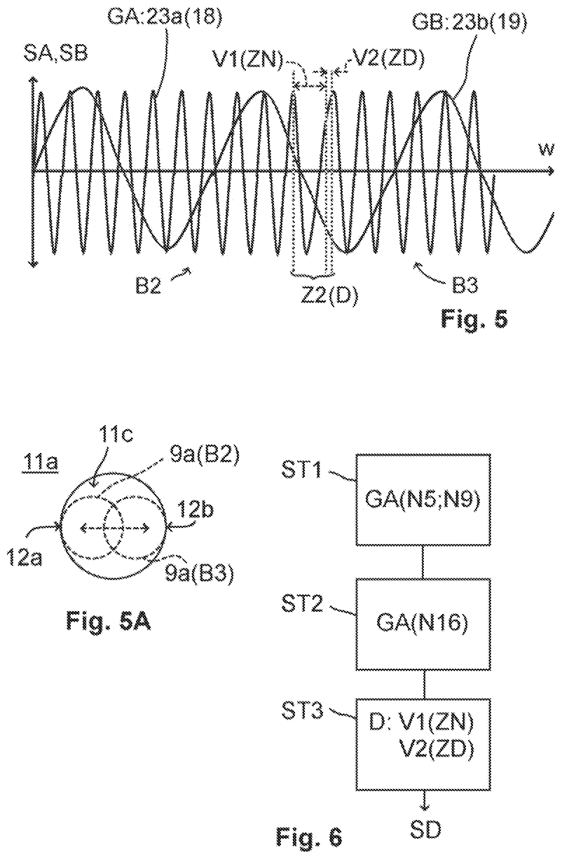

In this driving situation, the result is the oscillating curve 23a, 23b of the drive signal SA or the reference signal SB against the travel distance w shown in FIG. 5. As shown in FIG. 4, there is a deviation D in a second intermediate region Z2 between the read-in drive variable GA and the read-in reference variable GB. This deviation D is caused by the gearwheel play ZN1 in the gearbox 7 (normal state ZN, first offset V1), which now also occurs again coming from the acceleration phase (B2=>Z2=>B3). If this first offset V1 was previously learned by the monitoring unit 21 as the normal state ZN (see also FIG. 4), it can be identified again in the second intermediate region Z2. Based on the first offset V1 in the second intermediate region Z2, a defect state ZD of the drive train 3 is not yet concluded.

In addition, however, a second offset V2 can be identified in the second intermediate region Z2, which occurs in addition to the previously learned first offset V1 (normal state ZN) in the drive signal SA or in the oscillating drive curve 23a. This second offset V2 also contributes to the deviation D between the read-in drive variable GA and the read-in reference variable GB, since this also does not occur in FIG. 5 in the reference signal SB or in the oscillating reference curve 23b. Therefore, the second offset V2 also results from the rotational behavior in the drive train 3.

In the present case, it is concluded that the second offset V2 results from a defect in the drive train 3, which is caused, for example, by a loosened wheel nut 9b. Consequently, a defect state ZD of the drive train 3 assigned to the second offset V2 is determined and output via a defect signal SD. In the event of a loose wheel nut 9b, it is the case, for example, that in the second intermediate region Z2 a drive torque MA generated by the drive 5 is not transferred directly to the underlying surface 2 via the drive wheel 11 (comparable to the gearwheel play ZN1 in the gearbox 7). This results from the fact that the threaded bolts 9a located on the drive wheel hub 9 as shown in FIG. 5A can move in the holes 11c in the rim 11a of the drive wheel 11 in the event of a change of sign of the drive torque MA or in the case of a transition from a braking torque MB to a positive drive torque MA, that is, in the second intermediate region Z2. The drive wheel 11 thus initially follows the rotational behavior of the drive 5 with a delay.

This is shown schematically in FIG. 5A. Accordingly, the threaded bolt 9a is in contact with a front flank 12a of the hole 11c in the rim 11a in the second region B2, that is, with a positive drive torque MA. In the third region B3, that is, in the event of a negative drive torque MA or in the case of a braking torque MB, by contrast, the threaded bolt 9a is in contact with a rear flank 12b of the hole 11c. Consequently, in the second intermediate region Z2 between the second region B2 and the third region B3, a system change takes place, in which the threaded bolt 9a changes flanks 12a, 12b.

During this system change, the drive 5 rotates, which can be determined from the drive variable GA, but for a short time and one-time-only no torque is transferred to the drive wheel 11 and consequently not to the underlying surface 2, so that the second offset V2 occurs. The rotational behavior of the reference wheel 15 does not change, so that during the system change (12a<=>12b) there is a deviation D between the read-in drive variable GA and the read-in reference variable GB in the second intermediate region Z2. After detecting this deviation D in the form of the second offset V2, which does not normally occur, it can therefore be concluded that there is a defect state ZD of the drive train 3, since this second offset V2 does not correspond to the normal state ZN of the drive train 3.

This effect due to the system change can be seen particularly strongly in the second intermediate region Z2 during a transition from the driven state (B2) to the braking state (B3) since the described flank change occurs most significantly then. In principle, however, this effect can also be determined in the first intermediate region Z1 (B1=>B2) or in a third intermediate region Z3 (B3 (recuperation, braking)=>B4 (idling)) by analyzing the deviation D between the read-in drive variable GA and the read-in reference variable GB. In principle, this deviation D due to the system change can always be determined if the drive torque MA changes sign (B2<=>B3) or the drive torque increases (Z1: acceleration) from zero (idling/coasting) or decreases (deceleration) or the drive torque MA changes to zero (cf. Z3) starting from an acceleration phase or a braking phase (B3).

By comparing the read-in drive variable GA with the read-in reference variable GB or by determining a deviation D by the monitoring unit 21 in a third step ST3, a defect state ZD of the drive train 3 can be concluded while taking into account a previously determined or learned normal state ZN. Depending on this, the monitoring unit 21 can then output a defect signal SD, which is then further processed in such a way that it can react to the detected defect. For this purpose, depending on the defect signal SD, a display device 25 in the vehicle 1 can be actuated to indicate the defect to the driver. The latter can then react accordingly manually. However, it is also possible to automatically control the vehicle 1 depending on the defect signal SD, so that for example the vehicle is parked in a correspondingly automated manner and/or driven to a workshop for checking the defect.

The loose wheel nut 9b was only given as an example as a possible detectable defect state ZD of the drive train 3. However, there may also be other defects that do not occur in the normal state ZN of the drive train 3 and which also lead to a drive torque MA generated in the drive train 3 not being continuously transferred to the underlying surface 2 and via this to the reference wheel 15. All these effects can be detected by the determination according to the disclosure of the deviation D between the read-in drive variable GA and the read-in reference variable GB.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 vehicle
1a drive axle
1b reference axle
2 underlying surface
3 drive train of the vehicle 1
5 drive
5a electric motor
5b internal combustion engine
6 brakes
7 gearbox
9 drive wheel hub
9a threaded bolt
9b wheel nut
11 drive wheel
11a rim
11b tire
11c holes in the rim 11a
12a front flank
12b rear flank
13a first drive shaft
13b second drive shaft
15 reference wheel
16 reference wheel hub
17a drive revolution rate sensor
17b reference revolution rate sensor
18 motor revolution rate sensor
19 wheel revolution rate sensor
21 monitoring unit
23a oscillating drive curve of 17a; 18
23b oscillating reference curve of 17b; 19
25 display device
B1 first region (coasting)
B2 second region (acceleration)
B3 third region (braking, recuperation)
B4 fourth region (coasting)
dTa period length of 23a
dTb period length of 23b
D deviation
fa frequency of 23a
GA drive variable
GB reference variable
MA drive torque
MB braking torque
N5 motor revolution rate
N9 drive hub revolution rate
N11 drive wheel revolution rate
N15 reference wheel revolution rate
N16 reference hub revolution rate
SA drive signal
SB reference signal
SD defect signal
V1 first offset
V2 second offset
w travel distance
Z1 first intermediate region
Z2 second intermediate region
Z3 third intermediate region
ZN normal state
ZN1 gearwheel play in the gearbox 7
ZD defect state
ST1, ST2, ST3 steps of the method

1. A method for determining a defect state of a drive train of a vehicle, wherein the vehicle has a drive axle with a drive wheel and a reference axle with a reference wheel, wherein a drive torque generated by a drive is transferrable to an underlying surface by the drive train via the drive wheel and the drive torque of the drive is not transferrable to the underlying surface via the reference wheel of the reference axle, the method comprising:
reading-in a drive variable, wherein the drive variable is dependent on a motor revolution rate of the drive;
reading-in a reference variable, wherein the reference variable is dependent on a reference wheel revolution rate of the reference wheel;
determining whether there is a deviation between the read-in drive variable and the read-in reference variable for determining whether the reference wheel revolution rate of the reference wheel is related to the motor revolution rate of the drive, wherein if there is a deviation, the defect state of the drive train is concluded; and
outputting a state signal if the drive train is in the defect state.

2. The method of claim 1, wherein if there is a deviation between the read-in drive variable and the read-in reference variable, the defect state of the drive train is concluded, taking into account a normal state of the drive train.

3. The method of claim 2, wherein the defect state is not concluded if a deviation between the read-in drive variable and the read-in reference variable is caused only due to a normal state of the drive train; and, the drive train in the normal state does not have a defect despite a detected deviation between the read-in drive variable and the read-in reference variable.

4. The method of claim 3, wherein the deviation between the read-in drive variable and the read-in reference variable that can be detected in a normal state is learned in advance.

5. The method of claim 2, wherein a deviation between the read-in drive variable and the read-in reference variable in the normal state results from gearwheel play in a gearbox of the drive train.

6. The method of claim 1, wherein the defect state is concluded from a deviation between the read-in drive variable and the read-in reference variable only if this deviation occurs in the event of and/or as a result of at least one of:
a change in the drive torque transferred to the underlying surface via the drive wheel; and,
a change in a braking torque transferred to the underlying surface via the drive wheel.

7. The method of claim 6, wherein the defect state is concluded from a deviation between the read-in drive variable and the read-in reference variable only if this deviation results from:
the change in the drive torque of the drive with a sign change; or
the change in at least one of the drive torque of the drive and the braking torque to zero; or
the change in at least one of the drive torque of the drive and the braking torque starting from zero.

8. The method of claim 1, wherein the drive variable and the reference variable each have an oscillating curve; and, the drive variable and the reference variable are recorded by an incrementally measuring revolution rate sensor.

9. The method of claim 8, wherein the defect state of the drive train is concluded if the deviation is caused by a second offset in the drive variable; the second offset is caused by a changed period length of the oscillating curve of the drive variable; and, the second offset cannot be detected in the oscillating curve of the reference variable.

10. The method of claim 9, wherein the period length of the oscillating curve of the drive variable changes briefly and not periodically when the drive train is in the defect state.

11. The method of claim 1, wherein the drive train is in the defect state when a wheel nut fastening the drive wheel to a drive wheel hub is so loose that a deviation between the read-in drive variable and the read-in reference variable occurs in the event of at least one of a change in the drive torque transferred to the underlying surface via the drive wheel and a change in a braking torque transferred to the underlying surface via the drive wheel, since the reference wheel revolution rate of the reference wheel is at least temporarily no longer related to the motor revolution rate of the drive.

12. The method of claim 1, wherein at least one of:
the motor revolution rate of the drive and/or a drive hub revolution rate of a drive wheel hub in a same drive train is read-in as a drive variable, wherein the drive wheel is arranged on the drive wheel hub and the drive hub revolution rate corresponds to the motor revolution rate of the drive at least during the transfer of the drive torque; and,
a reference hub revolution rate of a reference wheel hub on the reference axle is read-in as a reference variable, wherein the reference wheel is arranged on the reference wheel hub.

13. A monitoring unit for a vehicle wherein the vehicle has a drive axle with a drive wheel and a reference axle with a reference wheel, wherein a drive torque generated by a drive is transferrable to an underlying surface by a drive train of the vehicle via the drive wheel and the drive torque of the drive cannot be transferred to the underlying surface via the reference wheel of the reference axle, the monitoring unit comprising:
a non-transitory storage medium having program code stored thereon;
said program code being configured, when executed by a processor, to:
read-in a drive variable, wherein the drive variable is dependent on a motor revolution rate of the drive of the vehicle;
read-in a reference variable, wherein the reference variable is dependent on a reference wheel revolution rate of the reference wheel of the vehicle;
determine whether there is a deviation between the read-in drive variable and the read-in reference variable in order to determine whether the reference wheel revolution rate of the reference wheel is related to the motor revolution rate of the drive, wherein if there is a deviation the monitoring unit can conclude that there is a defect state of the drive train of the vehicle; and,
output a state signal if the drive train is in the defect state.

14. A vehicle comprising:
a drive axle with a drive wheel;
a reference axle with a reference wheel;
a drive train;
a drive configured to generate a drive torque, wherein said drive torque is transferable to an underlying surface by said drive train via said drive wheel and said drive torque is not transferrable to the underlying surface via said reference wheel;
a drive revolution rate sensor being assigned to said drive axle and configured to determine a drive variable;
a reference revolution rate sensor being assigned to the reference axle and configured to determine a reference variable;
a monitoring unit including a non-transitory storage medium having program code stored thereon;
said program code being configured, when executed by a processor, to:
read-in the drive variable, wherein the drive variable is dependent on a motor revolution rate of the drive of the vehicle;
read-in the reference variable, wherein the reference variable is dependent on a reference wheel revolution rate of the reference wheel of the vehicle;
determine whether there is a deviation between the read-in drive variable and the read-in reference variable in order to determine whether the reference wheel revolution rate of the reference wheel is related to the motor revolution rate of the drive, wherein if there is a deviation, the monitoring unit can conclude that there is a defect state of the drive train of the vehicle; and,
output a state signal if the drive train is in the defect state.

15. The vehicle of claim 14, wherein said drive is an electric motor for generating the drive torque and the drive revolution rate sensor is a motor revolution rate sensor which directly detects the motor revolution rate as the drive variable.

16. The vehicle of claim 14, wherein the vehicle is a commercial vehicle.
